(19) United States
(12) Patent Application Publication
(10) Pub. No.: US 2012/0000368 A1
(43) Pub. Date: Jan. 5, 2012

(54) INTRODUCING A FALSE BOTTOM INTO A LAUTER TUN

(75) Inventor: Peter Deuter, Freising (DE)

(73) Assignee: KRONES AG, Neutraubling (DE)

(21) Appl. No.: 13/171,503

(22) Filed: Jun. 29, 2011

(30) Foreign Application Priority Data
Jul. 2, 2010 (DE) 102010030888.9

(51) Int. Cl. C12G 1/02; B23P 17/04

(52) U.S. Cl. 99/277; 29/428

(57) ABSTRACT

A method of introducing a false bottom comprising several false bottom elements into a lauter tun container, as well as a corresponding lauter tun, where, to introduce the false bottom or the false bottom elements, a false bottom introduction opening is provided in the lauter tun bottom through which the false bottom elements are introduced into the lauter tun container from the bottom.

### CROSS-REFERENCE TO RELATED APPLICATION

The present application claims the benefit of priority of German Application No. 102010030888.9, filed Jul. 2, 2010. The entire text of the priority application is incorporated herein by reference in its entirety.

### FIELD OF THE DISCLOSURE

The disclosure relates to a method of introducing a false bottom and to a lauter tun such as used in beer production.

### BACKGROUND

During lautering, a solid-liquid separation of the mash takes place. The liquid, also referred to as wort, is used for further wort or beer production. The solid components, referred to as spent grains, are a residual product which is used, for example, as fodder or for energy generation. The lauter tun is one of the oldest and widest spread lauter apparatuses. The lauter tun comprises a container over the bottom of which a slotted false bottom is provided. The mash is guided into the container, where the spent grains remain lying on the false bottom and the wort can drain downwards through the layer of spent grains and is thus filtered. During the manufacture of lauter tuns, first the container is made, and subsequently the individual elements or blades of the false bottom are introduced via an introduction opening. Up to now, the introduction openings for the false bottom elements have been arranged at the lateral cylinder walls of the housing or in the container hood.

With a corresponding introduction opening for false bottoms at the cylinder walls the false bottom elements must be introduced laterally, e.g. underneath an intermediate level or an intermediate ceiling (the region above an intermediate level being in particular the operating level, and the region underneath an intermediate level being the drive space.) For this reason, one has to provide a sufficiently large installation space in this region for introducing or removing the false bottoms. This leads to a considerable additional space requirement and can involve an enlargement of the building area or an enlargement of the lauter tun floor space. Basically, it is also possible, as mentioned above, to provide the introduction opening above the intermediate ceiling at the container lid. Such a solution, however, is disadvantageous due to the shape of the hood of the container and the complicated surface treatment involved. Moreover, such an introduction opening often does not satisfy the operator's aesthetic demands. Moreover, a leakage of the introduction opening in the operating level is particularly dangerous (passenger traffic) and at least leaves traces of liquids (e.g. water, cleansing agents) on the hood's surfaces, additionally being detrimental to aesthetics. Equally, lateral introduction at the cylinder walls above an intermediate level is possible, but this also involves the above mentioned disadvantages.

### BRIEF SUMMARY OF THE DISCLOSURE

Starting from this situation, one aspect underlying the present disclosure is to provide a method and a lauter tun which permit an easy introduction and removal of a false bottom or the false bottom elements, respectively.

So, in the manufacture of a lauter tun, the false bottom elements are introduced from the bottom into the lauter tun container through one or several false bottom introduction openings in the lauter tun bottom. This is advantageous as the space underneath the lauter tun is easily accessible and spacious and is not located at the operating but at the drive level. Accordingly, no additional lateral installation space is required. Preferably, in particular one false bottom introduction opening is provided. In a particularly advantageous embodiment, the latter is constructively fitted into the container bottom such that neither the means of the pipe system, nor retaining devices and/or other fittings and/or means are an impediment to an easy introduction. Thus, one can save a considerable amount of space as the lauter tun can be arranged, for example, very close to a wall or to another apparatus. By the false bottom elements being pushed in from the bottom via the false bottom introduction opening, the installation is essentially simplified. As the lauter tun bottom has a flat design, the false bottom introduction opening can be easily cut out.

Via the false bottom introduction opening, the false bottom elements, however, can also be brought to the outside, e.g. during maintenance works.

In the production of the lauter tun, the false bottom introduction opening is advantageously closed after the false bottom elements have been introduced. For this, e.g. a corresponding closing part can be produced.

It is advantageous if the part that was detached from the lauter tun bottom for making the false bottom introduction opening is used for closing the false bottom introduction opening. The detached part can be inserted into the opening. The detached part thus exactly fits into the opening to be flush with the adjacent areas. The gap between the part and the false bottom introduction opening is then advantageously sealed. In particular, a curable sealing material can be poured into the gap in a flat plane without gaps. Thus, the opening can be easily sealed. If a separately made closing element is introduced into the false bottom introduction opening, a corresponding gap can be correspondingly sealed.

Advantageously, the opening has a slot-like design. The false bottom elements can then be inserted through the slot essentially perpendicular to the lauter tun bottom. This permits a preferably small size of the false bottom introduction opening.

Advantageously, the false bottom introduction opening can be cut out in the lauter tun bottom already in the production of the bottom plate together with other openings that are provided in the bottom plate. This permits a particularly inexpensive production of the false bottom introduction opening.

In accordance with the disclosure, for the manufacture of the lauter tun, first the container is made, that means the lauter tun bottom is welded to the side walls of the container, where preferably the container hood is also already placed, and the false bottom elements are preferably subsequently introduced into the completed vessel from the bottom via the false bottom introduction opening.

So, the lauter tun according to the disclosure comprises a lauter tun bottom which comprises a false bottom introduction opening via which the false bottom elements can be introduced and also removed.

In operation, the false bottom introduction opening is in particular closed via a closing element so that the wort does not drain over the lauter tun bottom at this site. However, it would also be possible to not or to only partially close the false bottom introduction opening and thus purposefully drain and/or introduce wort and/or cleaning media via the false bottom introduction opening.

However, it is particularly advantageous for the closing element to include the part detached from the lauter tun bottom for making the false bottom introduction opening. The detached part can then be, for example, permanently fixed to a retainer, e.g. a frame or a plate, and be introduced from the bottom into the false bottom introduction opening. The retainer can then be fixed, for example, to the container bottom. The gap between the detached part and the false bottom introduction opening is then sealed. A curing sealing material is in particular poured into the gap. If a separately made closing element is used, a gap that is formed can be correspondingly sealed.

Advantageously, the false bottom introduction opening is embodied as a slot.

### BRIEF DESCRIPTION OF THE DRAWINGS

The disclosure will be illustrated below with reference to the following figures.

FIG. 1 schematically shows a longitudinal section through a lauter tun according to the present disclosure.

FIG. 2 shows a plan view of the false bottom shown in FIG. 1.

FIG. 3 schematically shows the lauter tun bottom on bars in a perspective representation.

FIG. 4 schematically shows the sub-structure of the lauter tun bottom in a perspective representation.

FIG. 5 schematically shows the false bottom introduction opening as well as a corresponding closing part in a perspective representation.

### DETAILED DESCRIPTION OF THE PREFERRED EMBODIMENT

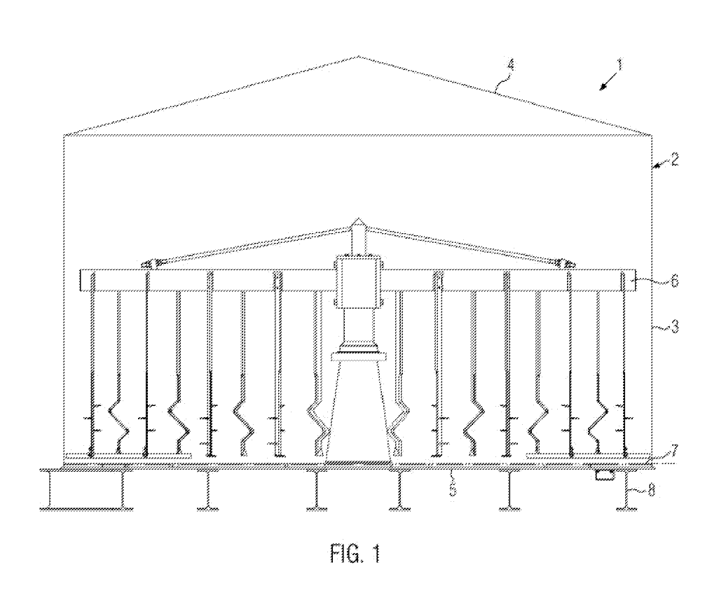

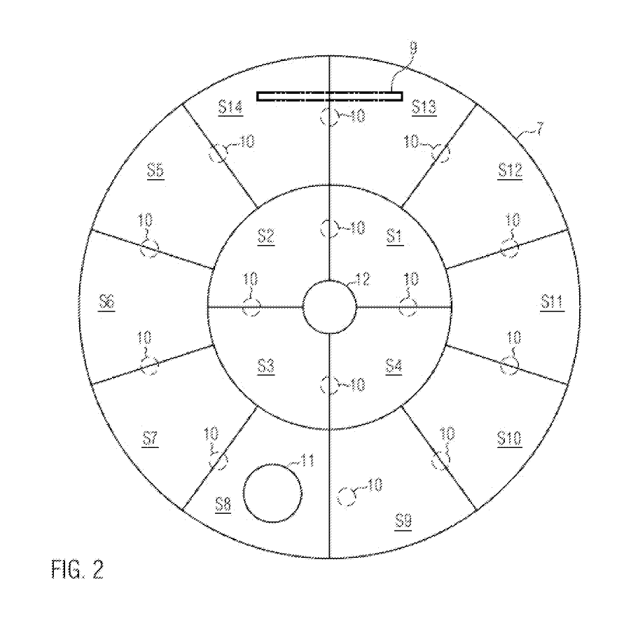

FIG. 1 shows a longitudinal section through a possible embodiment of a lauter tun 1 according to the present disclosure. In a well-known manner, a lauter tun comprises a lauter tun container 2 which here comprises e.g. a cylindrical wall 3, a hood 4 as well as a lauter tun bottom 5. The lauter tun bottom 5 is here arranged on bars, e.g. double T-bars 8, and can be fixed, for example, on a supporting frame by means of these bars. A second insertable false bottom 7 divided into several elements or segments S1 to S14 (see FIG. 2) is provided over the lauter tun bottom 5. The distance between the false bottom 7 and the tun bottom 5 is between 10 mm and 60 mm, e.g. approx. 20 mm. As can be taken from FIG. 2, the false bottom is divided into several false bottom elements which rest on corresponding support elements (not represented). In particular, the support elements are firmly connected to the bottom side of the false bottom elements. In FIG. 2, 14 false bottom elements S1 to S14 are shown. Depending on the size of the lauter tun 1, however, more or less false bottom elements can also be provided. The false bottom is embodied e.g. as a bar-screen bottom or as a slotted bottom (not represented) on which the spent grains remain lying and through which the filtered wort can drain. The individual false bottom elements for example have an area within a range of 0.5 m² to 1.5 m², e.g. ca. 1 m². As a free passage area is desired, the false bottom elements cannot be arbitrarily small. Too large false bottom elements, however, are difficult to handle. The thickness of the false bottom elements without support element is, for example, within a range of 3 to 10 mm.

A rotating raking and cutting machine 6 is provided within the lauter tun. The raking and cutting machine 6 serves to loosen the spent grains on the false bottom 7 and to push the spent grains out after the lautering process.

The false bottom has a central opening 12 for the raking machine transmission. Furthermore, the false bottom 7 has one or several openings 11 to push the spent grains out over a spent grain hatch. As is represented in a dotted line, there are several wort drain openings 10, i.e. lauter tappings underneath the false bottom level in the lauter tun bottom.

For the sake of simplicity, the mash supply line which introduces mash e.g. from the bottom into a region above the false bottom 7, a wort drain opening 10 via which the wort can be drained, for example via the container bottom 5, and corresponding pipe systems are not represented in FIG. 1.

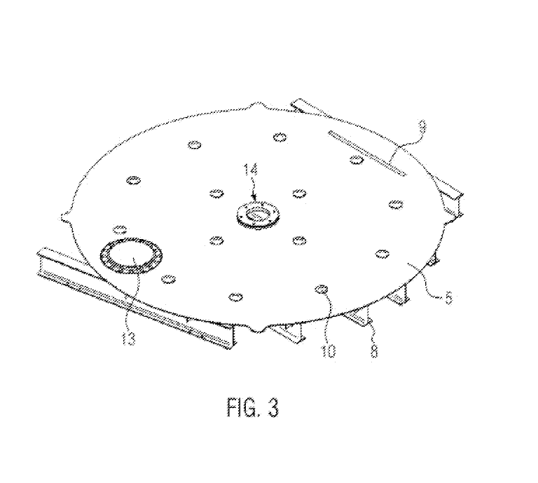

During the manufacture of the lauter tun, first the lauter tun container 2 is made, whereupon the false bottom 7, i.e. the false bottom elements S1 to S14, is then inserted. As can be taken e.g. from FIGS. 2 and 3, a false bottom introduction opening 9 is provided in the lauter tun bottom 5 for this. The false bottom introduction opening 9 is here embodied as a continuous slot whose width is larger than the thickness of the false bottom elements S1 to S14, and if spacer elements are already provided, larger than the thickness of the false bottom elements plus the height of the spacer elements, and whose length is selected such that the false bottom elements can be inserted into the lauter tun container 2 essentially perpendicularly to the lauter tun bottom 5 through the false bottom introduction opening 9. The slot width is advantageously within a range of 20 mm to 80 mm. The length depends on the size of the false bottom elements and is approximately within a range of 1000 mm to 1500 mm.

The false bottom introduction opening 9 is advantageously located between two bars 8. The lauter tun bottom is e.g. erected over a supporting frame at such a height that sufficient space is provided underneath the lauter tun bottom to introduce the false bottoms. Advantageously, the distance of the lauter tun bottom 5 from the bottom is 3 m to 7 m.

As can be taken from FIG. 3, which is a perspective representation of the lauter tun bottom 5, there are, apart from the false bottom introduction opening 9, e.g. also the above-mentioned wort drain openings 10 as well as an opening 14 for the raking machine transmission with a flange and an opening 13 for the spent grains with a flange in the lauter tun bottom 5.

The inserted false bottom elements, resting on corresponding supports, are then inserted into the lauter tun.

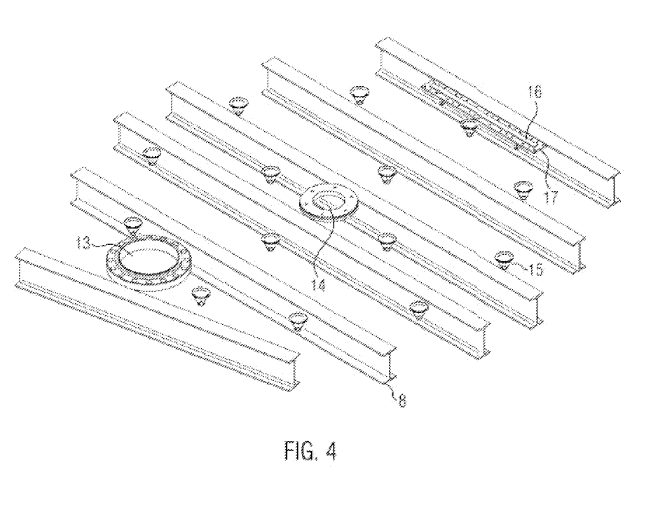

FIG. 4 shows, in a perspective representation, the lauter tun sub-structure with several lauter centering bells 15 which are attached at the wort drain openings or lauter tappings at the bottom side of the tun bottom. Furthermore, a flange is also arranged, namely at the central opening for the raking machine transmission, and a flange is arranged around the spent grains opening.

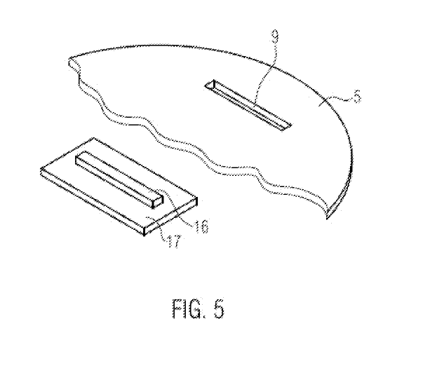

Advantageously, the false bottom introduction opening 9 is closed during the operation of the lauter tun. As can be taken from FIGS. 4 and 5, the false bottom introduction opening 9 is closed by a closing element 16 which is inserted into the opening 9. The closing element 16 can be manufactured separately and has such cross-sectional dimensions that it fits into the opening 9. It is advantageous for the closing element 16 to comprise the part 16 which had been detached from the lauter tun bottom 5 for making the false bottom introduction opening 9. The detached part can then be, for example, permanently fixed to a retainer, e.g. a frame or a plate, and be inserted into the false bottom introduction opening 9 from the bottom. The part 16 thus fits into the opening 9 to be flush with the adjacent areas. The retainer or the frame or the plate can be fixed on the container bottom 5, e.g. by screwing, so as to be detachable from the outside. The gap formed by detaching the part 16 should be sealed. Sealing can be accomplished by pouring in a curing sealing material (preferably a liquid, pasty polymer sealing agent, e.g. Terostat MS930) without gaps and in a flat plane.

The present disclosure was described in connection with a lauter tun which comprises several tap holes with a corresponding pipe system. The present disclosure is, however, equally suited for a lauter tun which comprises an annular collecting tank around its circumference into which wort can drain via outlet openings in the side walls 3 and/or in the bottom 5. Such a lauter tun is described, for example, in EP 1 384 773. The disclosure is equally suited for lauter tuns which have an annular container cross-section with an annular lauter area. Such a lauter tun is described, for example, in EP 1 325 951. The disclosure is not restricted to the mentioned embodiments but includes any possible lauter means with a false bottom.

In the method according to the disclosure, for the manufacture of the lauter tun, first the lauter tun container 2 is made, where the lauter tun bottom 5 is welded to the side wall or, in case of an annular lauter tun, to both side walls. The hood 4 can also be already placed on the side wall 3. In advance, corresponding openings, e.g. openings 10, 13, 14 (see FIG. 3), have already been cut out in the container bottom during the production of the bottom plate for the lauter tun bottom 5. Moreover, the false bottom introduction opening 9 has also already been cut out and the cut out part 16 attached to the retainer 17.

To introduce the false bottom elements S1 to S14, the false bottom elements can be manually inserted from the bottom essentially perpendicular to the lauter tun bottom 5 through the opening, here the slot 9, and placed onto corresponding supports. The insertion of the false bottom elements can be accomplished, for example, by a mechanic who entered the interior of the lauter tun, for example, via an access hatchway in the upper region of the lauter tun (not represented).

When all false bottom elements are introduced, the false bottom introduction opening 9 is closed by inserting e.g. the detached part 16 on the retainer 17 from the bottom into the opening 9. The retainer 17 is detachably fixed to the container bottom 5 from the bottom. The gap is, as described above, sealed by pouring in a sealing material.

Further manufacturing steps, such as for example the mounting of the raking and cutting machine or the corresponding pipe systems, etc., are not described here as these are well-known and not essential for the present disclosure.

If false bottom elements have to replaced, for example for maintenance purposes (e.g. if they have been damaged by the raking and cutting machine), the retainer 17 can be detached from the lauter tun bottom 5 and the opening 9 can be exposed by moving out the closing element 16 to then again introduce and remove false bottom elements. Subsequently, the opening 9 can be closed, e.g. as described above.

The Figures show the introduction opening in the right region outside the (not completely represented) pipe system region and within the support device, parallel to the external double T-bar. This construction is particularly advantageous for this design of a lauter tun. It is also conceivable to provide the false bottom introduction opening for example in the center of a lauter tun and/or not in parallel but at an angle at a distance to the bars, other retaining means also being possible.

1. Method of introducing a false bottom which comprises several false bottom elements into a lauter tun container, in particular in the manufacture or maintenance of a lauter tun, comprising introducing, the false bottom elements into the lauter tun container from the bottom through a false bottom introduction opening in the lauter tun bottom.

2. The method according to claim 1, and closing the false bottom introduction opening after the false bottom elements have been introduced.

3. The method according to claim 2, and, for making the false bottom introduction opening, detaching a part from the lauter tun bottom, and closing the false bottom introduction opening with this detached part.

4. The method according to claim 2, and sealing a gap between the detached part or the separately made closing element and the false bottom introduction opening.

5. The method according to claim 1, and wherein the false bottom introduction opening has a slot-like design.

6. The method according to claim 1, and cutting out the false bottom introduction opening in the lauter tun bottom during the manufacture of the bottom plate.

7. The method according to claim 1, and in the manufacture of the lauter tun, first making the closed lauter tun container, and then introducing the false bottom elements from the bottom via the false bottom introduction opening.

8. The method according to claim 1, and withdrawing false bottom elements through the false bottom introduction opening.

9. A lauter tun (1) with a lauter tun container, comprising a lauter tun bottom with a false bottom, the false bottom having several false bottom elements, and the lauter tun bottom comprising a false bottom introduction opening.

10. The lauter tun according to claim 9, wherein the false bottom introduction opening is closed in operation.

11. The lauter tun according to claim 17, wherein the closing element comprises a part detached from the lauter tun bottom to make the false bottom introduction opening.

12. The lauter tun according to claim 11, wherein the detached part is fixed to a retainer and introduced from the bottom into the false bottom introduction opening.

13. The lauter tun according to claim 17, wherein a gap between the detached part or the separately made closing element and the false bottom introduction opening is sealed.

14. The lauter tun according to claim 9, wherein the false bottom introduction opening is designed as a slot.

15. The method according to claim 2, where a closing element closes the false bottom introduction opening.

16. The method according to claim 4, wherein the sealing is created by pouring a curing sealing material into the gap.

17. The lauter tun according to claim 10, wherein the false bottom introduction opening is closed by a closing element.

18. The lauter tun according to claim 13, wherein the gap is sealed by using a curing sealing material poured into the gap.
